(19) United States
(12) Patent Application Publication
(10) Pub. No.: US 2007/0235960 A1
(43) Pub. Date: Oct. 11, 2007

(54) Creeper with powered adjustable back and headrest

(76) Inventor: Ronald M. Pantaleoni, Yuba City, CA (US)

Correspondence Address: R. MICHAEL WEST LAW OFFICES OF;R. MICHAEL WEST, A PROFESSIONAL CORPORATION, 455 CAPITOL MALL; SUITE 405, SACRAMENTO, CA, 95814-4603, US

(21) Appl. No.: 11/732,197

(22) Filed: Apr. 2, 2007

Related U.S. Application Data
(60) Provisional application No. 60/790,471, filed on Apr. 10, 2006.
(60) Provisional application No. 60/800,149, filed on May 15, 2006.

(51) Int. Cl. B25H 5/00

(52) U.S. Cl. 280/32.6

(57) ABSTRACT

A creeper including an elongated horizontal main frame having a top end and a bottom end. A plurality of wheels are mounted on the underside of the frame, providing creeper mobility. A sub-frame has a proximate end pivotally attached to the top end of the main frame, and a distal end movable from a lowered position to a raised position. Powered actuator means has a fixed portion attached to the top end of the frame and a movable portion attached to the distal end of the sub-frame. The movable portion may alternatively be driven from a retracted position to an extended position. Positive bias means extends from the top end of the frame to a region of said sub-frame between the proximate end and the distal end, and a negative bias means extends from the top end of the frame to the distal end of the sub-frame.

### PRIORITY CLAIM

Pursuant to the provisions of 35 U.S.C. § 119(e)(1), Applicant claims the priority of U.S. Provisional Patent Application Ser. No. 60/790,471, filed Apr. 10, 2006, and the priority of U.S. Provisional Patent Application Ser. No. 60/800,149, filed May 15, 2006.

### BACKGROUND OF THE INVENTION

1. Field of the Invention

The invention relates generally to the field of creepers, used by mechanics to slide under and work about the underside of automobiles, or other low-lying mechanical devices. More particularly, the invention pertains to creepers having a pivoted back and head rest support board which may be adjustably raised and lowered into a selected inclined position by manipulating a powered actuator.

2. Description of the Prior Art

U.S. Pat. No. 2,051,563, discloses an Automobile Mechanic's Creeper including an adjustable head board which is hingeably affixed to the front portion of the creeper. U.S. Pat. No. 2,054,598, issued to Goldenberg, shows a creeper having an adjustable headrest which is raised and lowered by a lever. U.S. Pat. No. 2,703,717, granted to Miller shows a creeper including tension springs extending between the frame and a lever arm to urge the headboard upwardly, out of the plane of the creeper bed. U.S. Pat. No. 6,702,305, issued to Miles, shows an Inclinable Creeper including a gas spring or a linear actuator, to raise a headrest to the desired inclined position.

### SUMMARY OF THE INVENTION

The creeper of the present invention is comprised of an elongated horizontal main frame, having a top end and a bottom end. A bottom cushion is provided on the frame for comfort of the user. A plurality of wheels are mounted on the underside of the frame, allowing the creeper frame to be moved about freely over a floor in any direction. A combined back and headrest cushion is mounted on a sub-frame. The sub-frame has a proximate end and a distal end. The proximate end is pivotally attached to the top end of the main frame of the creeper. The distal end is movable from a lowered position where the sub-frame is horizontal, to a raised position where the sub-frame and the attached cushion are inclined.

The creeper also includes at least one powered actuator, selectively extendable from a retracted position to an extended position, and selectively retractable from an extended position to a retracted position. The actuator has a fixed portion attached to the top end of the main frame and a movable portion attached to the distal end of the sub-frame.

At least one positive bias spring extends from the top end of the main frame to a region of the sub-frame between the proximate end and the distal end. The positive bias spring tends to urge the distal end of the sub-frame upwardly, thereby assisting the actuator in raising the sub-frame to the desired inclined position.

The creeper preferably includes at least one negative bias spring extending from the top end of the main frame to the distal end of the sub-frame. The negative bias spring tends to urge the distal end of the sub-frame downwardly to a lowered position. These downward forces progressively load the actuator as the sub-frame is raised, moderating the rate of its upward travel.

The powered actuator may be pneumatic, hydraulic, or electric in design. If one or more pneumatic actuators are used, an air reservoir may be provided on the creeper's main frame to provide a mobile supply of pressured air to drive the actuators.

### BRIEF DESCRIPTION OF THE DRAWINGS

FIG. 1 is a perspective view of the creeper with the adjustable back and headrest board in a lowered, horizontal position;

FIG. 2 is a view as in FIG. 1, but with the board in a raised, inclined position;

FIG. 3 is a perspective view of the creeper with the main board and the back and headrest board removed to show internal mechanical features;

FIG. 4 is a view as in FIG. 3, but with the sub-frame in a raised, inclined position;

FIG. 5 is a fragmentary, perspective view of a portion of the main frame, a portion of the sub-frame, a positive and a negative bias spring, and a pneumatically powered actuator;

FIG. 6 is a fragmentary, perspective view with one wall of the channel frame of the powered actuator removed to show inner details;

FIG. 7 is a perspective view of the pneumatic control assembly;

FIG. 8 is an exploded perspective view of a typical powered actuator;

FIG. 9 is an exploded perspective view of a pneumatic ram used in the powered actuator;

FIG. 10 is a fragmentary top plan view of a creeper showing a pair of powered pneumatic actuators, a single positive bias spring, and a pair of negative bias springs;

FIG. 11 is a fragmentary top plan view of a creeper showing a pair of powered hydraulic actuators, and a single positive bias spring, and negative bias means;

FIG. 12 is a fragmentary top plan view of a creeper showing a pair of powered pneumatic actuators including internal positive bias springs, and negative bias means;

FIG. 13 is a fragmentary top plan view of a creeper showing a single linear screw drive electric actuator, and a pair of positive bias springs adjacent the proximate end of the sub-frame;

FIG. 14 is a fragmentary cross-sectional view taken on the line 14-14 in FIG. 12, showing details of the internal positive bias spring in a pneumatic actuator;

FIG. 15 is a side elevational view of a creeper showing an air bladder actuator in combination with a positive bias spring and a negative bias spring; and,

FIG. 16 is a perspective view of the creeper shown in FIG. 15.

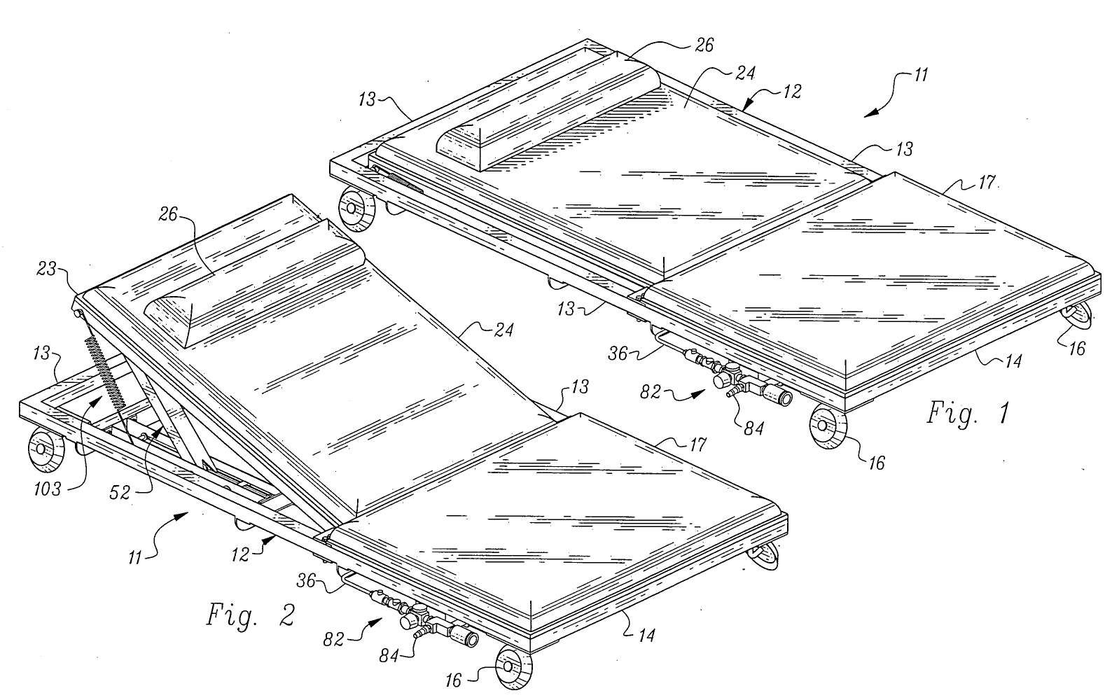

### DETAILED DESCRIPTION OF THE PREFERRED EMBODIMENT

Turning now to the drawings, the creeper 11 of the present invention includes an elongated horizontal main frame 12, having a top end 13 and a bottom end 14. A plurality of conventional wheels 16 are mounted on the underside of main frame 12, allowing the user to move the creeper in the desired direction over a support floor. A bottom cushion 17 is provided over the bottom end of main frame 12 to provide a comfortable sitting support for the user.

A sub-frame 18 is provided, having a proximate end 19 pivotally attached to opposing sides of the top end 13 of main frame 12. A bracket 21 and a bolt 22 on each of the opposing sides provide the means for pivotally attaching sub-frame 18. As is evident from FIGS. 2 and 4, the axis of rotation for sub-frame 18 is transverse to the longitudinal axis of main frame 12. Sub-frame 18 also includes a distal end 23, movable from a lowered position to a raised position. In its lowered position, sub-frame 18 generally lies in the plane defined by main frame 12. In its raised position, sub-frame 18 is inclined at an angle with respect to the plane of main frame 12. A back and headrest cushion 24 is provided on sub-frame 18. For additional comfort, an elongated head pillow 26 may also be provided on the upper end of cushion 24.

For the purpose of raising and lowering sub-frame 18, at least one powered actuator 27 is provided. Actuator 27 may be pneumatic, hydraulic, or electric in design, as all such designs are generally equivalent and all such designs will function satisfactorily for the purposes of powering the creeper 11 in the intended fashion. However, it is preferred that actuator 27 operate on pneumatic pressure, so that version of actuator 27 will be explained first and in greater detail. Designs for other actuators to be used in connection with the creeper construction will be discussed subsequently, and in a more general way.

Actuator 27 is selectively extendable from a retracted position to an extended position, and is selectively retractable from an extended position to a retracted position. Actuator 27 has a fixed portion 28 attached to the top end 13 of the main frame 12, and a movable portion 29 attached to distal end 23 of sub-frame 18.

The fixed portion 28 generally comprises a cylindrical ram housing 31, a mounting plate 32, and an elongated channel frame 33. On one end, ram housing 31 includes a pneumatic fitting 34, adapted to seal that end and provide a connection to an air supply and discharge line 36. On the other end, ram housing 31 has an end cap 37, provided with a bore 38. End cap 37 secures housing 31 to mounting plate 32 and provides a passageway for a movable portion of actuator 27. Elongated channel frame 33 is mounted parallel to the longitudinal axis of the main frame by means of end flanges 39, secured between cross brace 43 and cross brace 44. Channel frame 33 also has opposing walls 41 provided with respective opposing slots 42. A bolt 46 secured by a nut 48, maintains bumper discs 47 at a selected location along channel frame 33 to provide a transverse limit stop to the motion of the movable portion of actuator 27.

The movable portion 29 of actuator 27 generally comprises a ram rod 49, a heim joint 51, and an elongated arm 52. The end of rod 49 that travels within housing 31 includes a screw 53, washers 54, a cup seal 56, and another cup seal 57. These elements acting together provide a slidable pneumatic seal within housing 31 that provides translational forces to the end of rod 49. Bore 38 provides a passageway for rod 49, and maintains its axial alignment within housing 31. An alignment shaft 58 extends through an aperture 59 in rod 49, and has threaded end portions passing through opposing slots 42. Nuts 61 are installed on rod 49 on the inside of opposing walls 41. Nuts 62 and washers 63 are installed on rod 49 on the outside of walls 41. Alignment shaft 58 thereby serves to maintain rod 49 in horizontal alignment as it extends and retracts.

A threaded bore 64 is provided in the exposed end of rod 49. Heim joint 51 is threadably secured within bore 64. Bearings 66 and respective spacers 67 are provided on either side of heim joint 51. The diameter of bearings 66 is such that the outer periphery of the bearings rides along the floor of channel frame 33, providing a rolling low-friction support for arm 52. This assembly is secured within one end 68 of arm 52, which in turn is located within channel frame 33. For that purpose, a transverse bolt 69 is provided, passing through holes 71 in end 68, the slots 42, and the heim joint 51 assembly. Bolt 69 is secured with washers 72 and a nut 73. In that manner, extending and retracting translational forces applied by rod 49 are transferred to arm 52.

The other end 74 of arm 52 is provided with opposing holes 76. A U-shaped bracket 77 is mounted on the distal end 23 of sub-frame 18. Arm 52 is pivotally attached to the bracket 77 and the distal end of the sub-frame by means of a bolt 78 washers 79 and a nut 81. Movable portion 29 of actuator 27 is thereby pivotally connected to the distal end of sub-frame 18.

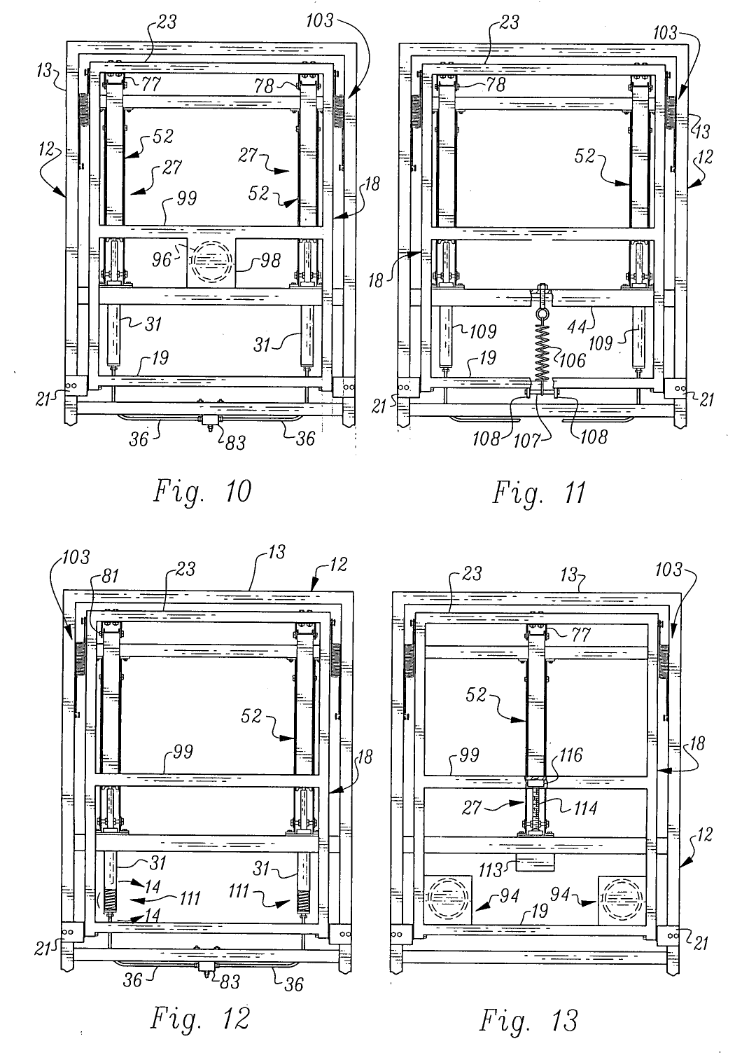

Air supply and discharge line 36 extends between pneumatic fitting 34 and pneumatic control assembly 82. In the event two actuators 27 are used, a T-fitting 83 is provided to interconnect the actuators with the control assembly 82, as shown in FIGS. 10 and 12. Control assembly 82 includes a quick-disconnect input connector 84, an air pressure control valve assembly 86, a quick-disconnect accessory connector 87, a manual air charge valve 88, and a manual air discharge valve 89.

An air reservoir 91 may be mounted on the frame 12, for the purpose of storing pressurized air to power the actuators 27 and any pneumatically powered accessories connected to connector 87. This feature is desirable, as it allows the user complete freedom to incline the head and backrest portion of the creeper without reliance on an air hose to provide pressurized air. Air line 92 extends between air distribution block 93 and reservoir 91, so that pressurized air supplied by an air compressor (not shown), may be supplied to connector 84 and charge reservoir 91. All components of pneumatic control assembly 82 are in pneumatic communication at all times, with the exception of discharge valve 89. Discharge valve 89 is positioned so that it may relieve air pressure in line 36 when actuated, but normally closed air charge valve 88 prevents the loss of air pressure stored in reservoir 91 when discharge valve 89 is actuated.

With sub-frame 18 in a horizontal position, the moment arm for lifting the back and headrest board upwardly is at its maximum. To assist the actuators 27 in pivoting the sub-frame 18 upwardly, at least one positive bias means 94 is provided. For that purpose, the lower end of a coil spring 96 is secured to a support plate 97 mounted on cross-brace 44 of frame 12. The upper end of spring 96 is confined by a compression plate 98, welded to a cross-brace 99 on sub-frame 18. Compression plate 98 is located in a position along sub-frame 18 which is intermediate the proximate end 19 and the distal end 23.

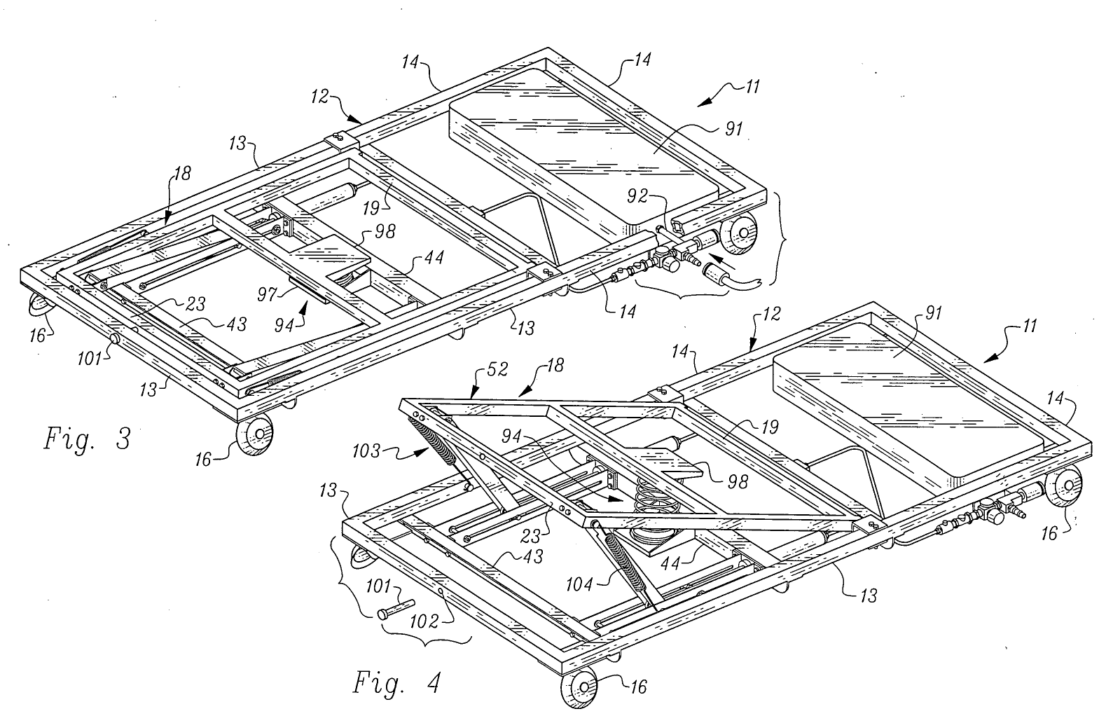

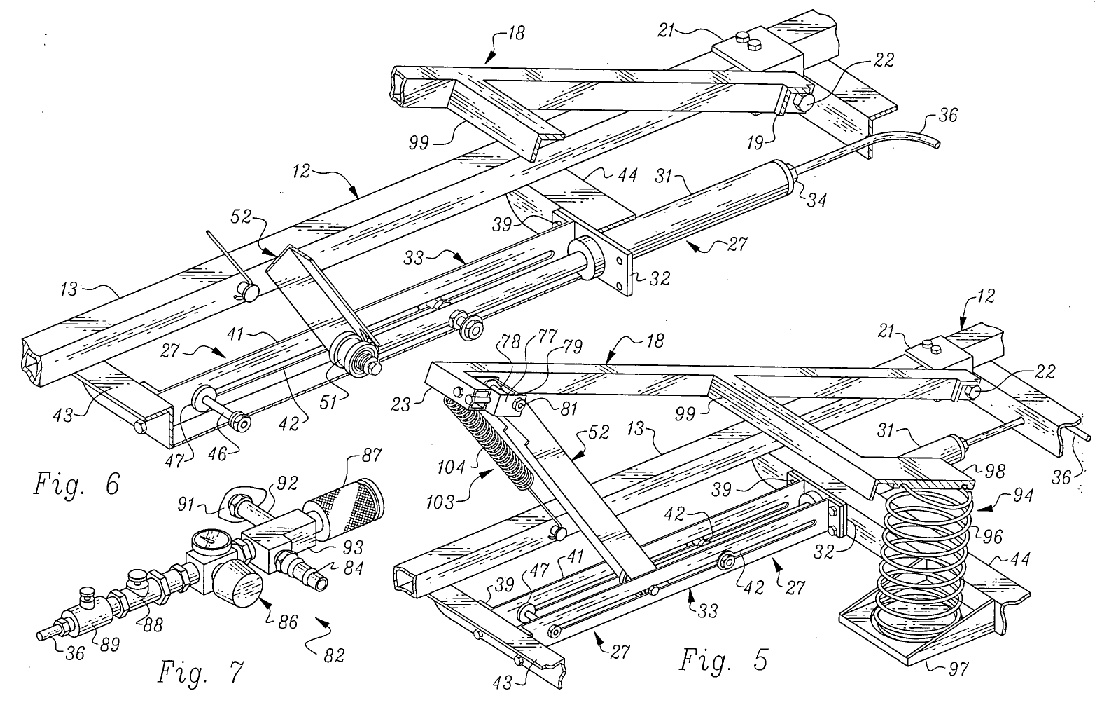

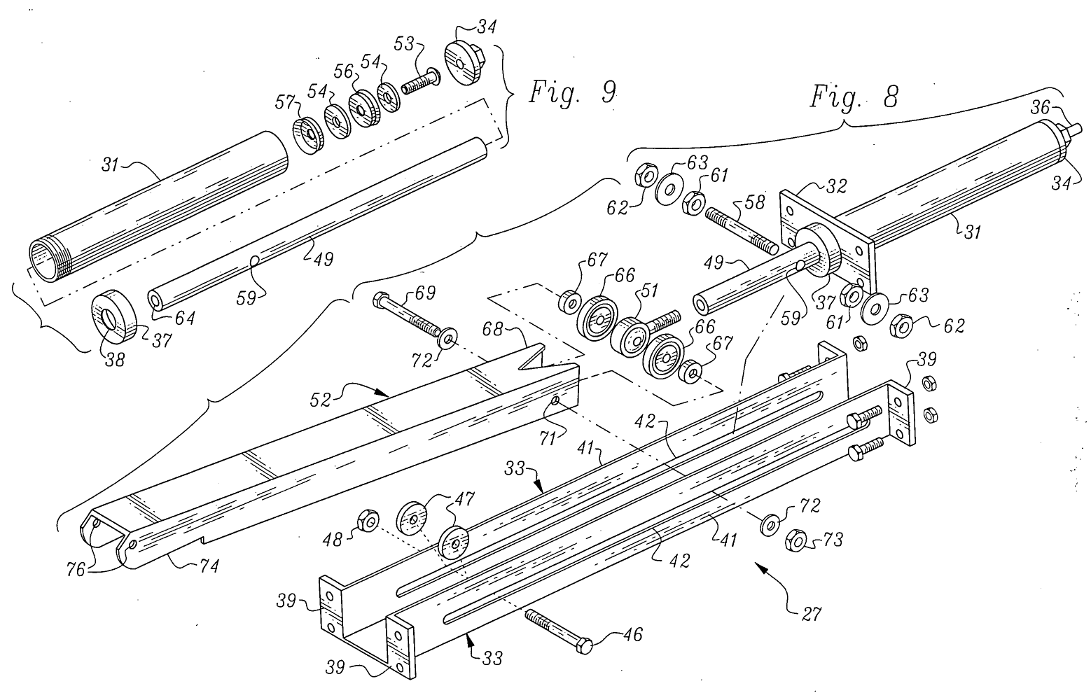

With actuators 27 fully retracted, as shown in FIG. 3, positive bias spring 96 is substantially compressed between plate 97 and compression plate 98. A pin 101 may be placed in aperture 102 to lock the sub-frame 18 in a horizontal position. This locked position may be used for storage, or when the user does not plan to incline the back and headrest support.

However, when it becomes desirable to raise the back and headrest support, the pin 101 is removed, and after positioning him or herself on the creeper, the user depresses the button on the air charge valve 88. The rod 49 in each actuator 27 is translated outwardly from the housing 31, to an extended position. In doing so, the one end 68 of each arm 52 is pushed away from housing 31, and the other end 74 of each arm is raised upwardly, through an arc. Likewise, attached distal end 32 of sub-frame 18 is raised upwardly, through an arc. Sub-frame 18 may be selectively positioned anywhere between a horizontal orientation to a fully raised and inclined position, such as that shown in FIG. 4. Upon releasing the button of valve 88, the sub-frame will not be raised any further. If the user has raised the sub-frame too high, or needs to lower the sub-frame to clear an obstruction, the user simply depresses the button on air discharge valve 89, and the sub-frame will be lowered under the weight of the inclined assembly and the user.

It has been determined through testing, that as the inclined back and headrest support rises upwardly, the sub-frame rises at an increasing rate. As the effective moment arm of the assembly shortens about its pivotal attachment to frame 12, the actuators have less work to do but the same amount of lifting force is being applied. In the interests of safety and to ensure a more controlled rate of ascent of the sub-frame, at least one negative bias means 103 may be employed. Negative bias means includes a coil spring 104 extending from the top end 13 of main frame 12 to the distal end 23 of sub-frame 18. Spring 104 tends to urge the distal end of the sub-frame downwardly to a lowered position. In other words, as spring 104 extends, its retractive tension forces increase and the work necessary to raise the sub-frame increases proportionately to the degree of spring extension. Thus, the speed of inclination of the sub-frame is moderated, and a degree of increased safety in use of the creeper 11 is provided.

There is a certain degree of interplay and exchange between the positive bias means 94 and the negative bias means 103, as the sub-frame moves through its range of motion. As the sub-frame initially rises, positive bias means 94 assists actuator 27 in moving the sub-frame 18 from a horizontal position to a partially inclined position. As the sub-frame 18 continues to rise, the lifting contribution of the positive bias means 94 continues to lessen, and the negative bias means 103 increases its influence by decreasing the speed of the raising operation. When the sub-frame is lowered, the opposite interplay and exchange occurs between the two opposing bias means.

Different variations and configurations of the creeper 11 are disclosed in FIGS. 11, 12, 13, and 14. In FIG. 11, the positive bias means is provided by the combination of a tension spring 106, extending between cross-brace 44 and bar 107. Bar 107 is supported by parallel ears 108, extending downwardly and outwardly from the proximate end 19 of sub-frame 18. The tension forces in spring 106 pull against bar 107 through the moment arm determined by the length of the ears 108, urging the sub-frame 18 upwardly. In addition, the actuators 27 used in the embodiment of the creeper in FIG. 11 use hydraulic rams 109. Through parallel-connected lines and controls (not shown), hydraulic rams 109 raise and allow the lowering of sub-frame 18 through its normal range of motion. Although more complicated and expensive, it would also be possible to use two-way hydraulic rams in this configuration, providing power raising and power lowering of the sub-frame.

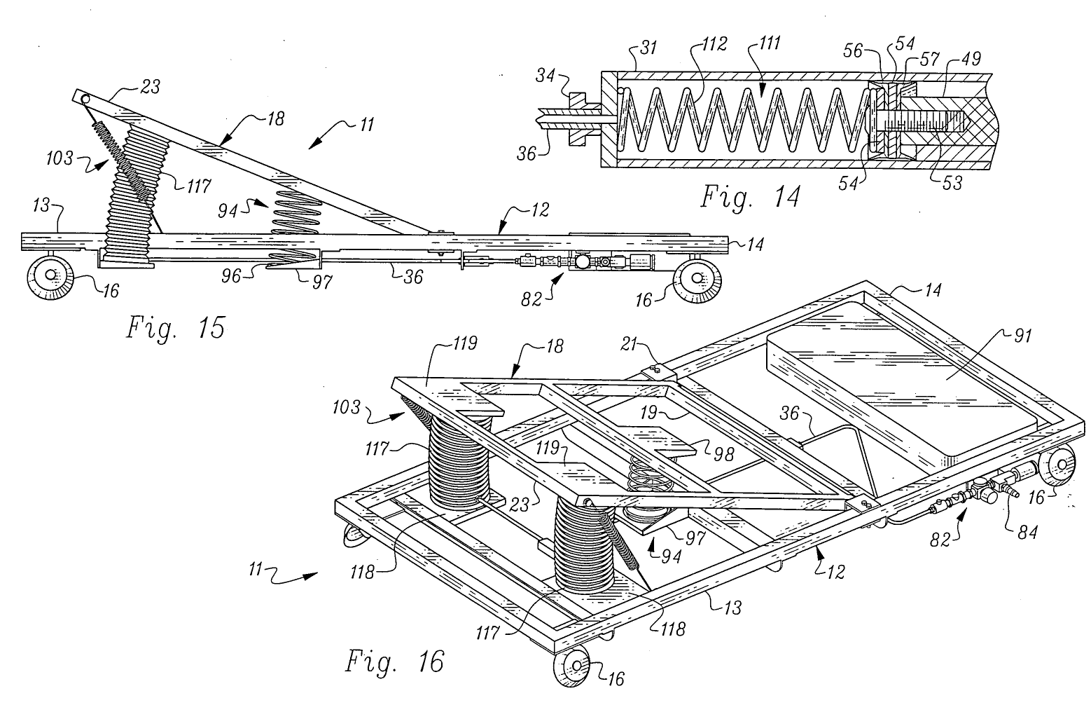

FIG. 12 shows a version of the creeper 11 using positive bias means which is internal to a pneumatic actuator. As is shown most clearly in FIG. 14, ram housing 31 includes a coil spring 111 which tends to bias rod 49 outwardly, effectively raising the attached sub-frame 18. This arrangement obviates the need for a separate external positive bias spring assembly, but is otherwise identical to the creeper 11 described above and shown in FIG. 10.

Yet another version of the creeper 11, shown in FIG. 13, uses an electrically powered actuator 27. Such linear drive actuators typically employ a reversible electric motor 113 coupled to a threaded drive shaft 114 and a nut 116. Nut 116 is attached to a shaft, which in turn is attached to arm 52. As the electric motor rotates shaft 114, nut 116 is translated either outwardly or inwardly, depending on the direction of rotation of shaft 114.

Lastly, at least one accordion-like air bag 117, shown in FIGS. 15 and 16, may be used to raise and allow the controlled lowering of the sub-frame. In this construction, a lower support plate 118 attached to frame 12 and an upper thrust plate 119 attached to sub-frame 18, act together to confine air bag 117 and transfer its expansive force and its contractive release to raising and lowering movement of the sub-frame. The use of many of the components required in the previously described actuators are eliminated, through employment of an expandable and compressible air bag 117, in lieu thereof. Otherwise, the creeper 111 shown in FIGS. 15 and 16 operates identically to those configurations and versions previously described.

What is claimed is:

1. A creeper, comprising:
a. an elongated horizontal main frame having a top end and a bottom end;
b. a plurality of wheels mounted on an underside of said main frame, said wheels allowing translation of said main frame over a support floor;
c. a sub-frame having a proximate end pivotally attached to said top end of said main frame, and a distal end movable from a lowered position to a raised position;
d. at least one actuator, extendable from a retracted position to an extended position, said actuator having a fixed portion attached to said top end of said main frame and a movable portion attached to said distal end of said sub-frame; and,
e. at least one positive bias spring extending from said top end of said main frame to a region of said sub-frame between said proximate end and said distal end, said positive bias spring tending to urge said distal end of said sub-frame upwardly to a raised position.

2. A creeper as in claim 1 further including at least one negative bias spring extending from said top end of said main frame to said distal end of said sub-frame, said negative bias spring tending to urge said distal end of said sub-frame downwardly to a lowered position.

3. A creeper as in claim 1 in which said actuator includes at least one pneumatic ram.

4. A creeper as in claim 1 in which said actuator includes at least one hydraulic ram.

5. A creeper as in claim 1 in which said actuator comprises at least one air bag, and further including an air supply and discharge line in pneumatic communication with said air bag.

6. A creeper as in claim 1 in which the axis of said sub-frame's pivotal attachment is transverse to the axis of said main frame.

7. A creeper as in claim 6 in which said actuator comprises an elongated channel frame, said channel frame being mounted parallel to the axis of said main frame, and having opposing walls provided with opposing slots.

8. A creeper as in claim 7 in which said actuator further includes an elongated arm having one end located within said channel frame and provided with a transverse shaft passing through said opposing slots and engaged therewith, an other end of said arm being pivotally attached to said distal end of said sub-frame, said actuator further including a ram with a housing attached to said main frame and an extendable rod attached to said one end of said arm.

9. A creeper as in claim 1 in which said top end of said main frame has opposing sides, and further including a pair of actuators each located on said opposing sides.

10. A creeper as in claim 9 in which said positive bias spring is centrally located between said opposing sides.

11. A creeper, comprising:
a. an elongated horizontal main frame having a top end and a bottom end, said top end having opposing sides;
b. a plurality of wheels mounted on an underside of said main frame, said wheels allowing translation of said main frame over a support floor;
c. a sub-frame having a proximate end pivotally attached to said opposing sides of said top end of said main frame, and a distal end movable from a lowered position to a raised position;
d. a pair of actuators, extendable from a retracted position to an extended position, each of said actuators having a fixed portion attached to said opposing sides of said top end of said main frame and a movable portion attached to said distal end of said sub-frame;
e. a positive bias spring extending from said top end of said main frame to a region of said sub-frame between said proximate end and said distal end, said positive bias spring tending to urge said distal end of said sub-frame upwardly to a raised position; and,
f. a negative bias spring extending from said top end of said main frame to said distal end of said sub-frame, said negative bias spring tending to urge said distal end of said sub-frame downwardly to a lowered position.

12. A creeper as in claim 11 in which each of said actuators includes a pneumatic ram.

13. A creeper as in claim 11 in which each of said actuators includes a hydraulic ram.

14. A creeper as in claim 11 in which each of said actuators comprises an air bag, and further including an air supply and discharge line in pneumatic communication with each of said air bags.

15. A creeper as in claim 11 in which each of said actuators comprises an elongated channel frame, said channel frame being mounted parallel to the axis of said main frame, and having opposing walls provided with opposing slots.

16. A creeper as in claim 15 in which each of said actuators further includes an elongated arm having one end located within said channel frame and provided with a transverse shaft passing through said opposing slots and engaged therewith, an other end of said arm being pivotally attached to said distal end of said sub-frame, each of said actuators further including a ram with a housing attached to said main frame and an extendable rod attached to said one end of said arm.

17. A creeper as in claim 16 in which said rams are pneumatic.

18. A creeper as in claim 17 in which each of said rams includes an air inlet port, and in which said inlet ports are connected together and fed by a common air supply line.

19. A creeper as in claim 18 in which said air supply line is connected to a manually actuated controller having an air supply valve to allow selective extension of said rams and an air discharge valve to allow selective retraction of said rams.

20. A creeper as in claim 16 in which said rams are hydraulic and in which each of said rams includes a hydraulic fluid inlet port connected to a common hydraulic fluid supply line.

21. A creeper, comprising:
a. an elongated horizontal main frame having a top end and a bottom end;
b. a plurality of wheels mounted on an underside of said main frame, said wheels allowing translation of said main frame over a support floor;
c. a sub-frame having a proximate end pivotally attached to said top end of said main frame, and a distal end movable from a lowered position to a raised position;
d. actuator means, said actuator means having a fixed portion attached to said top end of said main frame, and a movable portion attached to said distal end of said sub-frame and extendable from a retracted position to an extended position; and,
e. positive bias means extending from said top end of said main frame to a region of said sub-frame between said proximate end and said distal end, said positive bias means tending to urge said distal end of said sub-frame upwardly to a raised position.

22. A creeper as in claim 21 further including negative bias means extending from said top end of said main frame to said distal end of said sub-frame, said negative bias means tending to urge said distal end of said sub-frame downwardly to a lowered position.
